(19) United States
(12) Patent Application Publication
(10) Pub. No.: US 2022/0016987 A1
(43) Pub. Date: Jan. 20, 2022

(54) ELECTRIC VEHICLE AND METHOD OF FORMING A CHARGING CHAIN OF ELECTRIC VEHICLES

(71) Applicant: Vestel Elektronik Sanayi ve Ticaret A.S., Manisa (TR)

(72) Inventor: Çagdas DÖNER, Manisa (TR)

(21) Appl. No.: 17/294,093

(22) PCT Filed: Nov. 14, 2018
(86) PCT No.: PCT/EP2018/081251

§ 371 Date: May 14, 2021

(51) Int. Cl. B60L 53/126; B60L 53/30; B60L 53/53; B60L 58/10

(52) U.S. Cl. CPC B60L 53/126; B60L 53/305; B60L 2240/72; B60L 58/10; B60L 2240/54; B60L 53/53

(57) ABSTRACT

A vehicle has wireless power transfer devices at the front and rear of the vehicle. A charging chain of such vehicles is established. Each vehicle in the charging chain acts as one or more of a source in which the vehicle is a source of electrical power for another vehicle in the chain, a sink mode in which the vehicle is a sink of electrical power from another vehicle in the chain, and an intermediary in which the vehicle receives electrical power from one vehicle in the chain and passes the electrical power to another vehicle in the chain.

### TECHNICAL FIELD

The present disclosure relates to a method of forming a chain of electric vehicles to enable an electric vehicle to provide electric power to charge another electric vehicle and to an electric vehicle.

### BACKGROUND

Electric vehicles, including purely electric vehicles, which only use an electric motor for propulsion, and hybrid vehicles, which have both an internal combustion engine and an electric motor for propulsion, typically have one or more rechargeable batteries for storing electric charge for the electric motor. The capacity of the batteries is often a limiting factor. In particular, the batteries require frequent charging because the range of the vehicle, i.e. the distance that can be covered before recharging, is often limited. Fixed charging stations may be available at the vehicle owner's own premises or work place and sometimes in public areas, especially in towns and cities. There are many places, however, where a fixed charging station may not be readily available, such as in rural areas and on long motorway stretches, etc. In any event, it may not always be convenient or possible for a user to use a fixed charging station to recharge the vehicle's batteries.

### SUMMARY

According to a first aspect disclosed herein, there is provided a method of forming a chain of electric vehicles to enable an electric vehicle to provide electric power to charge another electric vehicle, the method comprising:

creating a chain data structure for the chain;

receiving a request from a vehicle to join the chain;

determining that said vehicle should be permitted to join the chain and updating the chain data structure to include an identifier of said vehicle;

receiving a request from a further vehicle to join the chain;

determining that said further vehicle should be permitted to join the chain and updating the chain data structure to include an identifier of said further vehicle;

whereby the chain of electric vehicles comprises at least three electric vehicles, the at least three electric vehicles being said vehicle, said further vehicle and a yet further vehicle which is either a vehicle that created the chain structure or another vehicle that has joined the chain; and

setting a mode for each vehicle in the chain, wherein the mode for a first vehicle is a source mode in which the first vehicle is a source of electrical power for another vehicle in the chain, the mode for a second vehicle is a sink mode in which the second vehicle is a sink of electrical power from the first vehicle, and the mode for a third vehicle is an intermediary mode in which the third vehicle receives electrical power from the first vehicle and passes the electrical power to the second vehicle.

This enables a number of vehicles to participate in a battery charging scheme, effectively in the form of a chain of vehicles. The vehicles may for example be stationary or moving through traffic together. A vehicle can receive electrical power from another vehicle if needed. A vehicle can give electrical power to another vehicle if, for example, it has a surplus of stored electrical power. The use of the intermediary mode for one or more vehicles in the chain enables power to be passed from one vehicle to another even if they are not adjacent each other in a queue of traffic or the like. The vehicle or vehicles acting in intermediary mode effectively act as a transmission bridge between a charging vehicle and a vehicle being charged.

The chain data structure for the chain may be created by a vehicle. In an example, that vehicle may in effect become the administrator for the chain. Alternatively, creation and/or administration of the chain may be distributed across the vehicles in the chain or may be carried out by some remote, centralised administrator device or computer which is in communication with the vehicles.

In an example, the chain data structure contains an identifier of the chain.

In an example, the method comprises advertising the existence of the chain using the identifier of the chain.

In an example, the method advertising the existence of the chain by wirelessly transmitting data concerning the chain for receipt by vehicles.

For example, the existence of the chain may be advertised by one of the vehicles wirelessly broadcasting or multicasting the identifier of the chain for receipt by other vehicles, or by some remote, centralised administrator device or computer wirelessly broadcasting or multicasting an identifier of the chain for receipt by other vehicles. On receipt of the identifier of the chain, other vehicles may apply to join the chain.

In an example, requests to join the chain include the identifier of the chain.

In an example, requests to join the chain include an indication of whether the vehicle is willing to be a source or a sink or an intermediary.

In an example, the method comprises refusing a request from a vehicle to join the chain if the vehicle is willing to be a source of electric power but has insufficient stored electric power.

In an example, the method comprises refusing a request from a vehicle to join the chain if the vehicle is willing to be a sink of electric power but there are insufficient sources of electric power in the chain.

In an example, the method comprises transmitting a charging chain map to each vehicle in the charging chain to indicate the order of vehicles in the charging chain and the direction of power transfer between the vehicles in the charging chain.

According to a second aspect disclosed herein, there is provided an electric vehicle, the electric vehicle comprising:

a rechargeable battery;

a first wireless power transfer device at the front of the vehicle such that the vehicle can pass electrical power to or receive electrical power from an external wireless power transfer device that is at the front of the vehicle;

a second wireless power transfer device at the rear of the vehicle such that the vehicle can pass electrical power to or receive electrical power from an external wireless power transfer device that is at the rear of the vehicle; and

a power line which is selectively operable to connect the first wireless power transfer device and the second wireless power transfer device;

whereby electrical power received at one of the first and second wireless power transfer devices from an external wireless power transfer device can be selectively passed to the other of the first and second wireless power transfer devices or to the rechargeable battery.

This enables the vehicle to pass electrical power to and receive electrical power from another electric vehicle. The vehicle can selectively act as a source of electrical power for another electric vehicle, in which the power is provided from the rechargeable battery or some other source, such as for example a solar panel on the vehicle; a sink of electrical power from another electric vehicle, with the power being used to charge the rechargeable battery; or an intermediary in which the vehicle receives electrical power from one vehicle and passes it to another vehicle.

In an example, the electric vehicle comprises:

a wireless transceiver for transmitting wireless signals for receipt by other electric vehicles and for receiving wireless signals transmitted by other electric vehicles;

the vehicle being arranged selectively to cause the wireless transceiver to one or more of:

transmit a request for the electric vehicle to join a chain of electric vehicles, and

receive a request from another electric vehicle to join a chain of electric vehicles.

In an example, the electric vehicle is arranged selectively to set a mode for the vehicle, wherein the mode is selected from:

a source mode in which the vehicle is a source of electrical power for another vehicle in a said chain,

a sink mode in which the vehicle is a sink of electrical power received from another vehicle in a said chain for charging the vehicle battery, and

an intermediary mode in which the vehicle receives electrical power from another vehicle in a said chain and passes the electrical power to yet another vehicle in a said chain.

In an example, the electric vehicle is arranged to transmit a request for the electric vehicle to join a chain of electric vehicles in which the request includes an indication of whether the vehicle is willing to be a source or a sink or an intermediary.

In an example, the electric vehicle is arranged to create a chain data structure for the chain of vehicles and to administer the chain of vehicles.

As the administrator, the vehicle may decide for example whether or not to admit other vehicles to the chain.

In an example, the electric vehicle is arranged to advertise the existence of the chain by wirelessly transmitting an identifier of the chain for receipt by other vehicles.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of an electric vehicle according to an aspect of the present disclosure;

FIG. 2 shows schematically an example of a plurality of vehicles arranged in a charging chain according to an aspect of the present disclosure;

FIG. 3 shows a flow diagram for an example of a method according to an aspect of the present disclosure; and

FIG. 4 shows schematically an example of charging directions for a number of vehicles in a charging chain.

### DETAILED DESCRIPTION

Unless the context requires otherwise, the term “electric vehicle” is used herein to describe any vehicle that uses, in part or exclusively, electric power to propel the vehicle. This includes purely electric vehicles, which only use an electric motor for propulsion, and hybrid vehicles, which have both an internal combustion engine and an electric motor for propulsion. The electric vehicle may be for example an automobile, a car, a bus or coach, a lorry, a motorcycle, etc.

In addition, for simplicity of language, reference will often be made to an electric vehicle doing something or taking some action or making a decision, etc. It will be understood that this will often mean some processor of the electric vehicle causing some action to be taken by the vehicle or some part of the vehicle or making a decision, etc., usually under software control.

Electric vehicles typically have one or more rechargeable batteries for storing electric charge for the electric motor. The batteries require frequent charging because the range of the vehicle, i.e. the distance that can be covered before recharging, is often limited because of the limited capacity of the battery to store electric charge. Fixed charging stations, which commonly use cables to connect to the rechargeable battery, may be available at the vehicle owner's own premises or work place and sometimes in public areas, especially in towns and cities. There are many places and situations, however, where a fixed charging station may not be readily available, such as in rural areas, on long motorway stretches, when a vehicle is stuck in slow moving traffic in a city, etc. In any event, it may not always be convenient or possible for a user to use a fixed charging station to recharge the vehicle's batteries.

Examples described herein enable a chain of electric vehicles to be formed in which the electric vehicles can pass electric power to each other for recharging batteries. Each electric vehicle may act as a source of electric power which is passed along the chain to charge one or more other electric vehicles in the chain, or as a sink of electric power to receive electric power from one or more other electric vehicles in the chain, or as an intermediary which passes electric power received from one electric vehicle in the chain to another vehicle in the chain without using any of the power to charge its own battery. This allows electric vehicles to charge each other without requiring the vehicles to access a fixed charging station. The use of the charging chain structure, in which for example an intermediary electric vehicle passes electric power received from one electric vehicle to another vehicle in the charging chain, provides a flexible approach to charging of electric vehicles.

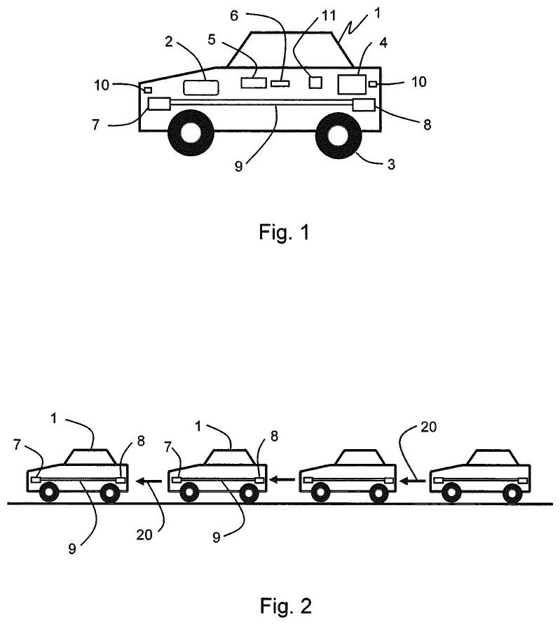

Referring now to the drawings, FIG. 1 shows schematically an example of an electric vehicle 1 according to an aspect of the present disclosure. As noted, the electric vehicle 1 may in general be any vehicle that uses exclusively or partially electric power for propulsion, including for example a purely electric vehicle or a hybrid vehicle.

The vehicle 1 has an electric motor 2 for driving one or more wheels 3 of the vehicle 1. The vehicle 1 has at least one rechargeable battery 4 for storing electric power for at least powering the electric motor 2. The vehicle 1 has a processor 5 for running computer programs, data storage and memory 6 for storing computer programs and data and providing working memory for the processor 5, etc.

The vehicle 1 has a first wireless power transfer device 7 at the front of the vehicle 1 and a second wireless power transfer device 8 at the rear of the vehicle 1. The first wireless power transfer device 7 may for example be located in or just behind the front bumper of the vehicle 1. The second wireless power transfer device 8 may for example be located in or just behind the rear bumper of the vehicle 1.

The wireless power transfer devices 7, 8 may in general be any type of wireless power transfer device. In this regard, wireless power techniques may generally be categorised as being near field or far-field. In near field or non-radiative techniques, power is transferred over short distances by magnetic fields using inductive coupling between coils of wire or by electric fields using capacitive coupling between metal electrodes. In far-field or radiative techniques, also called power beaming, power is transferred by beams of electromagnetic radiation. Inductive coupling, in which the wireless power transfer devices 7, 8 include coils, is the most widely used wireless technology and is likely the most practical for the present examples. Resonant inductive coupling may be used to increase the effective distance that is permitted or achievable between the interacting coils. Inverters may be provided to convert direct current (DC) from a vehicle battery to alternating current (AC) which is used to power the coils to transfer power to another coil. Likewise, rectifiers may be provided to convert AC received via a coil to DC which is used to charge the vehicle battery.

A power line 9 is arranged between the first wireless power transfer device 7 and the second wireless power transfer device 8. The power line 9 is operable so as to selectively connect the first wireless power transfer device 7 and the second wireless power transfer device 8 to transfer power between the power transfer devices 7, 8 when desired or commanded, as will be discussed further below. If no electric power is to be transferred between the power transfer devices 7, 8, then the power line 9 is effectively disconnected from one or both of the power transfer devices 7, 8.

The first wireless power transfer device 7 at the front of the vehicle 1 is able to transfer electric power to and receive electric power from another wireless power transfer device that is located somewhere towards the front of the vehicle 1. For example, the other wireless power transfer device may literally be located in front of the vehicle 1 or at least adjacent (say to the left or the right) of the front of the vehicle 1. Likewise, the second wireless power transfer device 8 at the rear of the vehicle 1 is able to transfer electric power to and receive electric power from another wireless power transfer device that is located somewhere towards the rear of the vehicle 1. For example, the other wireless power transfer device may literally be located behind the vehicle 1 or at least adjacent (say to the left or the right) of the rear of the vehicle 1. As will become clear, that means for example that the vehicle 1 can transfer power to or receive power from other vehicles 1 when the vehicles 1 are arranged linearly, front-to-back, or when the vehicles 1 are arranged side-by-side. This means that the present charging arrangement may be used when for example the vehicles 1 are moving together in a line or side-by-side, or when for example the vehicles are stationary, such as parked in for example a car park or parking lot (when at least some vehicles will be parked side-by-side) or parked in a street (when at least some vehicles will be parked front-to-back) or halted at a red light at a road junction, etc.

The vehicle 1 may have proximity sensors 10 which detect the presence of a neighbouring vehicle 1 and measure the distance to a neighbouring vehicle 1. There may for example be proximity sensors 10 at or towards the front and rear of the vehicle 1. Readings from the proximity sensors 10 may be used, by for example the processor 5 of the vehicle 1, to detect whether another vehicle 1 is physically close enough to allow electric power to be transferred between the vehicles 1 using the wireless power transfer devices 7, 8 of the respective vehicles 1. The processor 5 of the vehicle 1 may cause an audible and/or visual alarm to be generated to warn a driver of a vehicle 1 if the vehicle 1 is moving or has moved too far from a neighbouring vehicle 1 for an effective transfer of electric power to take place. The proximity sensors 10 may be for example ultrasonic or electromagnetic sensors, etc.

In addition, the vehicle 1 has a wireless transceiver 11 for transmitting wireless signals for receipt by other electric vehicles 1 and for receiving wireless signals transmitted by other electric vehicles 1. The wireless transceiver 11 may for example establish a local wireless connection with another vehicle via at least one of Bluetooth, Wi-Fi, infrared and ZigBee or some other local wireless communication technique.

FIG. 2 shows schematically an example of a plurality of vehicles 1 arranged in a charging chain according to an aspect of the present disclosure. The vehicles 1 may in general be moving or stationary, and may change from being moving or being stationary over time.

Examples of how to establish and operate the (logical) charging chain of vehicles 1 will now be described. In general, there are four main parts to this:
1. Charging Chain Establishment
2. Inter Vehicle Communication
3. Charge Transmission Control
4. Payment

Examples of each of these will now be described.

For “1. Charging Chain Establishment”, in general the charging chain requires some initiator to establish the charging chain in the first place. This may be some centralised resource, such as one or more remote servers with which electric vehicles can communicate over say a wireless network, such as for example a cellular or other wireless network. Alternatively or additionally, the initiator for establishing the charging chain may be one of the electric vehicles 1, which may be called a “parent electric vehicle”.

The decision to establish a charging chain may be an automated process. For example, a particular vehicle 1 may determine that it has a large amount of electric power stored in its battery 4 at a particular time and calculates that it can transfer some of that electric power to other vehicles 1 to charge their batteries. As another example, a particular vehicle 1 may determine that the level of charge in its battery 4 is low and therefore that the battery 4 needs recharging. As another example, a particular vehicle 1 may determine that it is able and willing to act as an intermediary to pass passes electric power received from one electric vehicle to another vehicle. In any of these cases, the electric vehicle 1 may decide to establish a charging chain of electric vehicles 1. Instead of or in addition to carrying this out automatically, this may be carried out manually, by for example a driver or other user of a vehicle 1 making the decision to establish a charging chain.

Whether a vehicle 1 has a large amount of electric power stored in its battery 4 and can transfer some to another vehicle 1, or requires electric power from another vehicle 1 to recharge is battery 4, may be based on for example threshold levels of charge in the battery 4. Alternatively or additionally, this may be a more intelligent decision, which is based on for example normal driving habits of the driver, including for example typical routes followed by the driver and driving patterns of the driver, distance to home or distance to a workplace or shopping centre, etc.

Any electric vehicle 1 that joins the established charging chain may be called a “child electric vehicle”.

In addition to this division in this example between a parent electric vehicle which created the charging chain and a child electric vehicle which joined the charging chain, each vehicle 1 in the chain has a “mode” which denotes or defines its role in the charging chain. In this example, there are three modes:

1. source electric vehicle. This is an electric vehicle that is able to join the charging chain to send electric power to charge other vehicles. Simply put, a source electric vehicle basically shares its battery power with other vehicles in the chain.

2. sink electric vehicle. This is an electric vehicle that requires charging by electric power received from source electric vehicles in the charging chain. A sink electric vehicle receives power to charge its own battery.

3. intermediary electric vehicle. This is an electric vehicle that passes or transfers power received from one electric vehicle in the chain to another electric vehicle in the chain. An intermediary electric vehicle acts as a transmission bridge or line to transfer power between source and sink electric vehicles.

It should be noted that the mode for a particular electric vehicle 1 in the chain may change over time. Also, any particular electric vehicle may be operating according to more than one mode simultaneously. For example, a particular electric vehicle 1 may be acting as a source of electric power for other vehicles or a sink of electric power from other vehicles, whilst at the same time acting as an intermediary also to pass electric power received from one vehicle to another vehicle.

The charging chain has an administrator function which controls the admission of electric vehicles to the chain and controls which vehicles can act as sources or sinks or intermediaries, etc., and generally administers the functioning of the chain and the vehicles in the chain. This administrator function may in general be carried out by some remote server or servers with which electric vehicles can communicate over say a wireless network (and which may have established the chain in some examples). In other examples, the administrator function may be carried out by a particular one of the vehicles 1 in the chain, such as for example the parent electric vehicle 1 in the case that the chain was established by an electric vehicle. As another example, the administrator function may be carried out by a plurality of vehicles in the chain, using for example distributed logic which is implemented across the vehicles, with the vehicles communicating with each other as necessary.

The administrator function may apply rules which determine whether an electric vehicle can join the charging chain, whether an electric vehicle can be a source or a sink of electric power or an intermediary for transferring electric power from one vehicle to another, etc. Such rules and any thresholds used for the rules may change and adapt over time, during for example operation of the charging chain, to take into account for example vehicles that have joined or left the charging chain, or that have been charged or no longer have excess charge that can be transferred to other vehicles, etc.

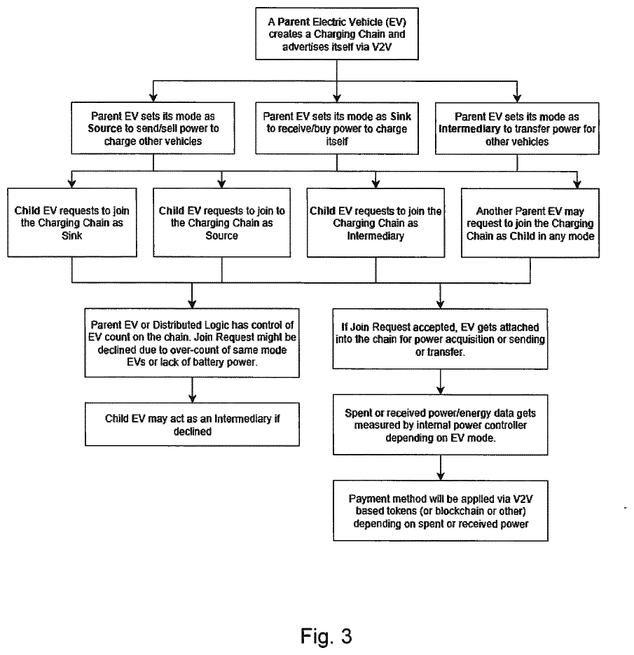

Reference is made briefly to FIG. 3. This shows a flow diagram for an example of a method according to an aspect of the present disclosure. Reference may be made to FIG. 3 for examples of some of the actions and decisions which may be taken at various stages during establishment and operation of a charging chain of vehicles. Other actions and decisions not shown in FIG. 3 may also be taken. The example of FIG. 3 assumes that one electric vehicle 1 (the “parent” electric vehicle 1) established and administers the chain.

As some examples of the rules that may be applied by the parent electric vehicle 1 or other administrator function, requests from vehicles to join the chain may be accepted or rejected.

For example, a request from an unsuitable vehicle, such as a vehicle that is not an electric vehicle, to join the chain may be rejected.

As another example, a request from a sink electric vehicle (i.e. a vehicle which desires or requires electric charging) to join the chain may be rejected if for example there are already too many sink electric vehicles in the chain. This recognises that having too many sink electric vehicles in the chain may mean that there is not sufficient electric power in one or more source electric vehicles to adequately or properly charge the sink electric vehicles. This may be based on a simple count of the number of sink electric vehicles in the chain or a ratio of number of sink electric vehicles in the chain to source electric vehicles in the chain. More sophisticated rules may take into account the amount of electric power that is available in the or each source electric vehicle and the amount of electric power that is required or requested by the or each sink electric vehicle.

As another example, a request from a source electric vehicle (i.e. a vehicle which claims to have sufficient electric charge to be able to charge other electric vehicles) to join the chain may be rejected if for example the level of battery charge for that vehicle is too low.

As further examples of the rules that may be applied by the parent electric vehicle 1 or other administrator function, the maximum level of electric power that can be transferred from one vehicle to another and the minimum duration of time for which a vehicle must join the charging chain may be controlled and adjusted.

Returning to the four main parts of how to establish and operate the (logical) charging chain of vehicles 1, the second item “2. Inter Vehicle Communication” mentioned above is used to enable the vehicles 1 to communicate with each other, for example to advertise the existence of the chain, ask to join the chain, receive commands from the administrator function (such as the parent electric vehicle), etc.

In this regard, there exist a number of proposals for vehicle-to-vehicle or V2V communication. For example, one proposal is so-called dedicated short-range communications (DSRC) V2V. This is a Wi-Fi variant and is defined by the IEEE 802.11p standard. DSRC devices work in the 5.9 GHz band with a bandwidth of 75 MHz. That spectrum is divided up into seven 10 MHz channels. The standard uses 52 subcarrier OFDM (orthogonal frequency-division multiplexing) to achieve a data rate of 3 to 27 Mb/s. The range is approximately 300 m.

In the present example, all data communication between the electric vehicles 1 takes place on a higher level protocol scheme which is powered or underpinned by V2V communication protocols. The higher level protocol may be text-based to enable or facilitate meaningful data exchange between the electric vehicles 1.

The administrator function, such as a parent electric vehicle or some centralised resource which created the chain, creates and stores a data structure for the chain. This may include initially at least some identifier of the chain. Subsequently, as electric vehicles join the chain and leave the chain, the data structure is updated to record details of current members of the chain, whether they are a source or sink or intermediary, the level of charge in the rechargeable batteries of the vehicles, etc.

In line with this, messages between the electric vehicles 1 may generally have the following structure:

| | | | |
|---|---|---|---|
| Chain ID | Electric Vehicle ID | Action | Data/Mode |

Chain ID is an identifier of the chain of vehicles.

Electric Vehicle ID is an identifier of the vehicle sending the message or the intended recipient of the message, depending on for example the action that is to be taken by a recipient of the message.

Action specifies an action to be taken. Some examples of actions include Advertise, Join, Leave, ConfigureDuration, ConfigureMinPercentage and ConfigureMaxEVCount. Here, Advertise is used when the message is to advertise the existence of the chain. Join and Leave are used by vehicles that want to join or leave the chain, or are used by the administrator function to allow a vehicle to join or leave the chain. ConfigureDuration, ConfigureMinPercentage and ConfigureMaxEVCount respectively indicate the minimum duration of time for which a vehicle must join the charging chain, a minimum battery charge level to be a source, and the maximum number of electric vehicles permitted in the chain.

Data/Mode specifies some data for the message or the mode of the vehicle sending the message or the intended recipient of the message, depending on for example the action that is to be taken by a recipient of the message. For example, the sink mode may be indicated by 0x01, the source mode may be indicated by 0x02, and the intermediary mode may be indicated by 0x03.

With this basic structure for the messages, a first example of a message that advertises establishment of the charging chain, which may be sent by for example the parent electric vehicle 1 that established the chain may be:

| | | | |
|---|---|---|---|
| 0x0001 | 0x00FF | Advertise | 0x01 |

This message indicates that for a chain with identifier 0x0001, the electric vehicle with identifier 0x00FF is the parent vehicle which is sending the message. The parent vehicle also wants to be a sink of electric power from other vehicles, as indicated by the 0x01 in the final portion of the message.

An example of a message sent by a vehicle wanting to join the chain may be as follows:

| | | | |
|---|---|---|---|
| 0x0001 | 0x00AA | Join | 0x02 |

This message indicates that for the chain with identifier 0x0001, the electric vehicle with identifier 0x00AA wants to join the chain as a source of electric power.

An example of a message sent by the parent vehicle to change the minimum of duration of time for which a vehicle must join the charging chain may be as follows:

| | | | |
|---|---|---|---|
| 0x0001 | 0x00FF | ConfigureDuration | 0x0A |

This message indicates that for the chain with identifier 0x0001, the parent vehicle with identifier 0x00FF has changed the minimum duration of time for a vehicle to join the charging chain to a time with a value corresponding to 0x0A.

In an example of this, a message that configures the charging chain, including for examples messages of the type just discussed, may be considered valid if and only if the message is sent by the parent vehicle with established the charging chain.

Returning to the four main parts of how to establish and operate the (logical) charging chain of vehicles 1, the third item “3. Charge Transmission Control” is used to control the sending and acquisition of electric charge by the vehicles in the chain.

For example, as noted, when an electric vehicle wants to receive electric charge from another electric vehicle, the electric vehicle needs to join a charging chain and set itself as a sink; when an electric vehicle wants to transfer electric charge to another electric vehicle, the electric vehicle needs to join a charging chain and set itself as a source; and when an electric charge would like to join to charging chain but not as a source or sink but as an intermediary, then the electric vehicle needs to join a charging chain and set itself as an intermediary so as to pass or transfer electrical power received from a source electric vehicle in the charging chain.

As mentioned above, in examples the electric vehicles 1 have a power line 9 which is operable so as to selectively connect the first (front) wireless power transfer device 7 and the second (rear) wireless power transfer device 8 of the vehicle 1 to transfer power between the power transfer devices 7, 8 when desired or commanded. In that case, the electric vehicle 1 can merely act to transfer power from one electric vehicle 1 to another without itself consuming electric power provided by the source electric vehicle 1. A charge storage device, such as for example another rechargeable battery or some other device that can store electrical power and that is separate from the vehicle main battery 4, may be provided for the power line 9. This can be arranged such that if the vehicle 1 is acting as an intermediary and has received electrical power from one vehicle but cannot at that moment pass the charge to another vehicle for some reason, then the intermediary vehicle 1 can temporarily store the charge and pass it on to the other vehicle when that becomes possible again.

It may be noted that for electric vehicles 1 that have both a first (front) wireless power transfer device 7 and a second (rear) wireless power transfer device 8, power transfer may selectively take place be in one of two directions, namely front to rear and rear to front.

As part of the Charge Transmission Control, each vehicle 1 may have a power transmission module, which may for example be implemented in software running on the processor of the vehicle 1 or separately. The power transmission module controls the charge acquisition between the wireless power transfer devices 7, 8 of the vehicle 1. In particular, in general in a charging chain, there may be several sources and several sinks in the chain. So, for example, a source electric vehicle 1 and a sink electric vehicle 1 might also be an intermediary electric vehicle 1. In such a case, the power transmission module may adjust the ratio of the power to be used or consumed by a particular electric vehicle 1 to charge the battery 4 of the vehicle 1 and the power that is transferred or passed for use by another vehicle 1 in the charging chain. This ratio may be defined via the configuration messages sent by the parent electric vehicle 1 of the charging chain or a pre-defined ratio might be used. It may be noted that if the charging chain contains more than one sink of electric power, then, in general, the electric power received at one sink electric vehicle cannot be used entirely by that vehicle as other vehicles also require electric charge, and so that vehicle needs to pass on or transfer some of the charge as an intermediary.

Referring again to FIG. 2, this shows schematically an example of a plurality of vehicles 1 arranged in a charging chain. In this example, the charging direction 20, i.e. the direction of power acquisition, is forwards, i.e. from a vehicle 1 that is at or towards the rear of the chain towards a vehicle 1 that is at or towards the front of the chain. To arrange the charging direction, a Charging Chain Map may be shared with all electric vehicles 1 in the chain. The parent electric vehicle 1 or other administrator function may wirelessly transmit the Charging Chain Map for receipt by all other vehicles 1 in the chain. Each vehicle 1 in the charging chain will set its charging direction (i.e. from front to rear or from rear to front) according to the order of the electric vehicles in the Charging Chain Map. An example Charging Chain Map may be as follows:

| Electric | | | | | |
|---|---|---|---|---|---|
| vehicle | | | | | |
| order | 1 | 2 | 3 | 4 | 5 |
| Electric | 0x00FF | 0x00AA | 0x001B | 0x002C | 0x003D |
| vehicle ID | | | | | |
| Electric | Sink | Source | Source | Sink | Source |
| vehicle | | | | | |
| mode | | | | | |

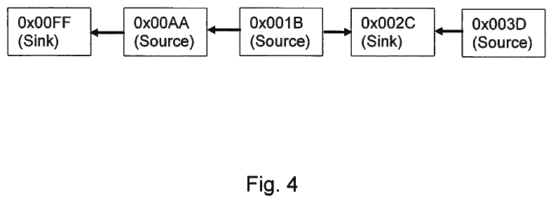

This would result in charging directions for the individual electric vehicles in this example as illustrated in FIG. 4.

In addition, the Charging Chain Map may be used to (logically) cluster the vehicles in the charging chain into groups, which can facilitate communication with the vehicles. For example, there may be a first cluster or group for all vehicles acting as sinks, a second cluster or group for all vehicles acting as sources, and a third cluster or group for all vehicles acting as intermediaries. Communications, such as messages transmitted by the parent vehicle or other administration function, can then be sent to the relevant vehicles by addressing the message to the corresponding cluster or group.

Returning to the four main parts of how to establish and operate the (logical) charging chain of vehicles 1, the fourth item “4. Payment” mentioned above is concerned with ensuring that sources of electrical power are compensated for providing the power, that sinks of electrical power pay for the power they have taken, and that intermediaries are compensated for providing the service of passing power from a source to a sink. A number of options for this are possible.

For example, the payment mechanism may be a token-based mechanism. Exchange of tokens may be made via V2V communications between the vehicles, using for example DSRC. The value of electric power that is provided by a source or taken or consumed by a sink may be measured in units of energy. A unit commonly used by power utilities and the like for measuring power is kilowatt hours or kWh. A price for each kilowatt hour may be set or predetermined (and may change from time to time according to for example current energy prices). In addition, if a particular vehicle is not acting as a source or sink and is only acting as an intermediary, then the intermediary may be paid a certain amount per unit time (such as per minute) for acting as an intermediary. This can help to encourage users having their electric vehicle 1 join a charging chain as an intermediary, which increases the scope and coverage of the charging chain.

As a simple illustrative example in a token-based system, payment tokens may be passed between vehicles in the charging chain as follows:

Source for 1 kWh->+10 tokens

Sink for 1 kWh->−25 tokens

Intermediary for 1 minute->+1 token

Double Power (2×1 kWh) for fast charge->100 tokens

With regard to the Double Power for fast charging, a vehicle 1 may request a fast charge, with power being provided at double the “normal” rate. This may be provided by for example two source vehicles, each providing power at the normal rate. The recipient vehicle 1 would pay a premium for this service.

Examples described herein enable a number of vehicles to participate in a battery charging scheme, effectively in the form of a chain of vehicles. Some vehicles may act as sources of power to charge other vehicles, some vehicles may act as sinks of power received from other vehicles, other vehicles may act as intermediaries to pass power from one vehicle to another. Some vehicles may act with a mix of roles of for example source and intermediary or sink and intermediary. The vehicles may in general all be stationary, parked at for example some car park or in a street. The vehicles may all be moving. With current technology, power transfer is likely to be more successful and efficient with vehicles that are stationary or only moving slowly, such as when moving through busy traffic. However, there are many proposals for vehicles effectively to be “locked” to each other when moving fast, in a form of convoy, using for example proximity sensors and computer control to control the speed of the vehicles. In such a case when the vehicles are electric vehicles, power can be transferred between vehicles even when moving at high speed. In this respect, the only limiting factor is that the wireless power transfer devices 7, 8 have to be close enough to each other in order for power to be transferred efficiently.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (including for example a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice.

The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of forming a chain of electric vehicles to enable an electric vehicle to provide electric power to charge another electric vehicle, the method comprising:
creating a chain data structure for the chain;
receiving a request from a vehicle to join the chain;
determining that said vehicle should be permitted to join the chain and updating the chain data structure to include an identifier of said vehicle;
receiving a request from a further vehicle to join the chain;
determining that said further vehicle should be permitted to join the chain and updating the chain data structure to include an identifier of said further vehicle;
whereby the chain of electric vehicles comprises at least three electric vehicles, the at least three electric vehicles being said vehicle, said further vehicle and a yet further vehicle which is either a vehicle that created the chain structure or another vehicle that has joined the chain; and
setting a mode for each vehicle in the chain, wherein the mode for a first vehicle is a source mode in which the first vehicle is a source of electrical power for another vehicle in the chain, the mode for a second vehicle is a sink mode in which the second vehicle is a sink of electrical power from the first vehicle, and the mode for a third vehicle is an intermediary mode in which the third vehicle receives electrical power from the first vehicle and passes the electrical power to the second vehicle.

2. A method according to claim 1, wherein the chain data structure contains an identifier of the chain.

3. A method according to claim 2, comprising advertising the existence of the chain using the identifier of the chain.

4. A method according to claim 3, comprising advertising the existence of the chain by wirelessly transmitting data concerning the chain for receipt by vehicles.

5. A method according to claim 2, wherein requests to join the chain include the identifier of the chain.

6. A method according to claim 1, wherein requests to join the chain include an indication of whether the vehicle is willing to be a source or a sink or an intermediary.

7. A method according to claim 1, comprising refusing a request from a vehicle to join the chain if the vehicle is willing to be a source of electric power but has insufficient stored electric power.

8. A method according to claim 1, comprising refusing a request from a vehicle to join the chain if the vehicle is willing to be a sink of electric power but there are insufficient sources of electric power in the chain.

9. A method according to claim 1, comprising transmitting a charging chain map to each vehicle in the charging chain to indicate the order of vehicles in the charging chain and the direction of power transfer between the vehicles in the charging chain.

10. An electric vehicle, the electric vehicle comprising:
a rechargeable battery;
a first wireless power transfer device at the front of the vehicle such that the vehicle can pass electrical power to or receive electrical power from an external wireless power transfer device that is at the front of the vehicle;
a second wireless power transfer device at the rear of the vehicle such that the vehicle can pass electrical power to or receive electrical power from an external wireless power transfer device that is at the rear of the vehicle; and
a power line which is selectively operable to connect the first wireless power transfer device and the second wireless power transfer device;
whereby electrical power received at one of the first and second wireless power transfer devices from an external wireless power transfer device can be selectively passed to the other of the first and second wireless power transfer devices or to the rechargeable battery.

11. An electric vehicle according to claim 10, comprising:
a wireless transceiver for transmitting wireless signals for receipt by other electric vehicles and for receiving wireless signals transmitted by other electric vehicles;
the vehicle being arranged selectively to cause the wireless transceiver to one or more of:
transmit a request for the electric vehicle to join a chain of electric vehicles, and
receive a request from another electric vehicle to join a chain of electric vehicles.

12. An electric vehicle according to claim 11, the vehicle being arranged selectively to set a mode for the vehicle, wherein the mode is selected from:
a source mode in which the vehicle is a source of electrical power for another vehicle in a said chain,
a sink mode in which the vehicle is a sink of electrical power received from another vehicle in a said chain for charging the vehicle battery, and
an intermediary mode in which the vehicle receives electrical power from another vehicle in a said chain and passes the electrical power to yet another vehicle in a said chain.

13. An electric vehicle according to claim 12, wherein the vehicle is arranged to transmit a request for the electric vehicle to join a chain of electric vehicles in which the request includes an indication of whether the vehicle is willing to be a source or a sink or an intermediary.

14. An electric vehicle according to claim 11, wherein the vehicle is arranged to create a chain data structure for the chain of vehicles and to administer the chain of vehicles.

15. An electric vehicle according to claim 14, wherein the vehicle is arranged to advertise the existence of the chain by wirelessly transmitting an identifier of the chain for receipt by other vehicles.
